(19) United States
(12) Patent Application Publication
(10) Pub. No.: US 2003/0070904 A1
(43) Pub. Date: Apr. 17, 2003

(54) Dowel drive for increased torque transfer

(76) Inventor: Kevin R Klubertanz, Fort Atkinson, WI (US)

Correspondence Address: Denise L Stoker, Godfrey & Kahn, 780 North Water Street, Milwaukee, WI, 53202, US

(21) Appl. No.: 10/048,368

(22) PCT Filed: Jan. 8, 2001
(86) PCT No.: PCT/US01/00534

(51) Int. Cl. B65G 33/34

(52) U.S. Cl. 198/674; 119/57.7

(57) ABSTRACT

A torque transfer assembly (30a, 30b, 30c) is assembled with reinforced fasteners (44) so that it may withstand the shear forces created by torque loads. The reinforcement is provided by surrounding the portion of a fastener subjected to shear stress with a sleeve-like tube key (40).

### CROSS-REFERENCE TO RELATED APPLICATION

This application claims the benefit of U.S. Provisional Application No. 60/175,162, filed Jan. 7, 2000.

### BACKGROUND OF THE INVENTION

The present invention relates generally to torque transfer assemblies and, more particularly, to a torque transfer assembly assembled with reinforced fasteners so that it can better withstand shear force.

Torque transfer assemblies, i.e. sprocket assemblies, are used to transmit torque in a wide variety of applications, from bicycles to clocks to industrial sized augers. Some of these applications require very little torque to perform a given function, i.e. a wristwatch. Other applications may experience high torque, i.e. auger systems that are used to literally move tons of materials such as concrete, rock, or agricultural products.

Many torque transfer assemblies are composed of disks, i.e. sprockets, spaced apart along a rotational axis. The disks are often held together with bolts that have their longitudinal axes aligned with the rotational axis. Thus, when one sprocket or disk is subjected to a load that is resisted by the connected sprockets or disks, the bolts experience shear forces. Such resistance can occur when a driving disk is trying to turn a shaft that is connected to a loaded disk, i.e. when a motor is driving an auger by means of a sprocket assembly.

As an example, a typical prior-art sprocket assembly 10 is shown in FIG. 1. The weakest point of such an assembly is on the bolt threads 24 where the stub shaft 12 and sprocket 14 meet. The bolts 20 can experience shear failure at this point. The problem could be alleviated by using larger diameter bolts or bolts made of a higher strength material, or by increasing the bolt circle. However, these are undesirable solution because such bolts are significantly more expensive, and increasing the bolt circle would require a shaft that is bulkier, heavier, and more expensive. Thus, there remains a need for a fastener that will not readily experience shear failure due to high torque loads, and not significantly increase the cost or bulkiness of the torque transfer assembly.

### SUMMARY OF THE INVENTION

Therefore, in view of the problems associated with the above torque transfer assemblies, it is an object of the present invention to provide a reinforced torque transfer assembly that 1) can withstand relatively high shear stresses, 2) can be used with existing torque transfer assemblies with only minimal modification, and 3) does not significantly increase the cost of the torque transfer assembly.

These and other objectives are met by the reinforced torque transfer assembly of the present invention. For the purpose of demonstration, the torque transfer assembly is shown in use in a sprocket assembly in particular a sprocket assembly used to transmit torque to an auger system used in an agricultural application. This example is not intended to limit the scope of the invention.

In one aspect of the present invention, a torque transfer assembly is composed of at least one disk member and a shaft. The disk member is attached to the shaft with at least one fastener that is reinforced with a tube key. The disk member may be a sprocket or the like wherein the sprocket is mounted onto the shaft with the reinforced fastener so that the tube key is positioned on a portion of the fastener that experiences shear stress. In another aspect of the present invention, a method of driving an auger with the reinforced torque transfer assembly is claimed. In the method, a torque transfer assembly is presented. The torque transfer assembly is composed of at least a first disk member and a second disk member attached to a shaft with reinforced fasteners. The auger is attached to the torque transfer assembly. Finally, the first disk member is rotated in order to drive the auger.

In another aspect of the present invention, a mixing tank, i.e. for mixing hay and the like, composed one or more augers each connected to a torque transfer assembly. The torque transfer assembly is composed of a at least one disk mounted onto a shaft with tube-key reinforced fasteners.

The present invention will be better understood from the following detailed description of the invention, read in connection with the drawings as hereinafter described.

### BRIEF DESCRIPTION OF THE DRAWINGS

FIG. 1 is a front end view of a prior-art bolted torque transfer assembly;

FIG. 2 is a cross-sectional view of the bolted torque transfer assembly of FIG. 1 taken along lines 2-2, showing the engagement of bolts through stacked sprockets and into a stub shaft;

FIG. 3 is a front end view of an embodiment of a reinforced torque transfer assembly according to the invention, showing stacked sprockets mounted on the stub shaft;

FIG. 4 is a cross-sectional view of the reinforced torque transfer assembly of FIG. 3 taken along lines 44, showing the engagement of a tube key and bolts through the stacked sprockets and into the stub shaft;

FIG. 5 is a cross-sectional view of another embodiment of a reinforced torque transfer assembly, showing stacked sprockets;

FIG. 6 is a cross-sectional view of another embodiment of a reinforced torque transfer assembly, showing a single sprocket mounted on the stub shaft;

FIG. 7 is a perspective view of the reinforced torque transfer assemblies of FIGS. 3-6, mounted in an auger-type feed mixer; and

FIG. 8 is a perspective view of the assembly of FIG. 1 attached to an auger drive shaft.

FIG. 9. is a perspective view of a prior-art mixer assembly.

### DESCRIPTION OF THE PREFERRED EMBODIMENT

The invention provides an apparatus and method of power transfer that increases the torsional load carrying capacity of a torque transfer assembly, wherein the assembly is composed of disk members held together with fasteners such as threaded bolts.

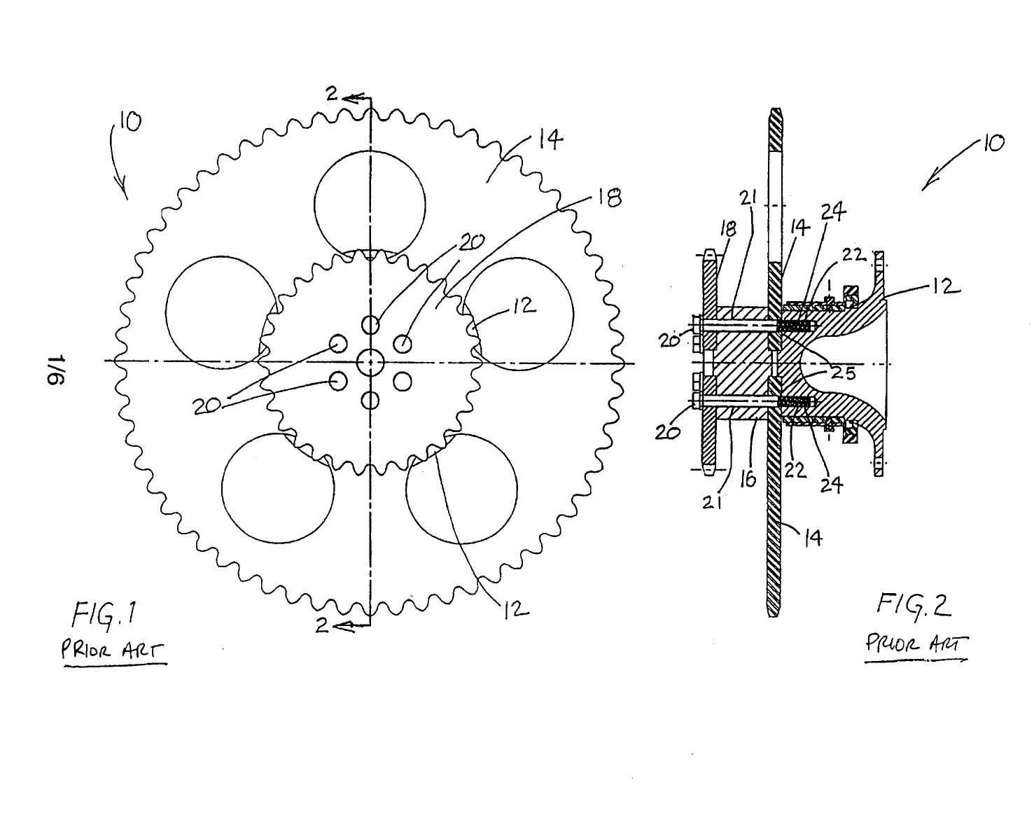

FIGS. 1 and 2 illustrate a sample prior-art torque transfer assembly 10. As shown by example of a sprocket assembly, assembly 10 includes a shaft such as stub shaft 12, a large diameter sprocket 14, a sprocket spacer 16, and a small diameter sprocket 18. The sprockets 14, 18 are stacked together with spacer 16 therebetween, and mounted onto stub shaft 12 with threaded bolts 20. Specifically, threaded bolts 20 extend into a bore 21 through sprockets 14, 18 and spacer 16, and a bore 22 in stub shaft 12. Bores 21, 22 are substantially parallel to the rotational axis of the shaft such as stub shaft 12. The function of bolts 20 is to keep sprocket spacer 16 and the rest of the sprocket assembly connected to stub shaft 12. However, in the prior art assembly 10, the bolt threads cause stress concentrations on the bolt shaft. Therefore, the threaded portion 24 on bolts 20 is the weakest part of the bolt. Problematically, this part of bolt 20 supports the highest amount of shear stress with the assembly being linked to and supported at joint 25 between sprocket 14 and stub shaft 12 by threaded part 24 of bolts 20. Consequently, bolts 20 linking sprockets 14, 18 to stub shaft 12 can fail due to shear stress. This can also be true for non-threaded fasteners.

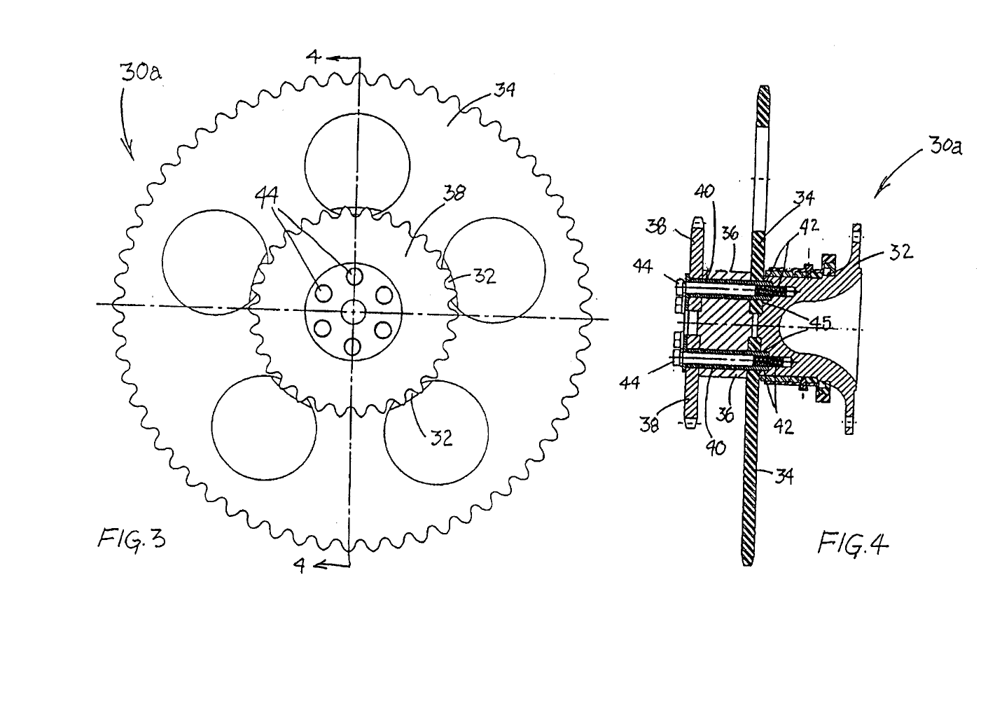

FIGS. 3 and 4 depict an embodiment of a reinforced torque transfer assembly 30a, according to the invention. The assembly 30a includes a shaft such as a stub shaft 32, a large diameter sprocket 34, a sprocket spacer 36, and a small diameter sprocket 38. The sprockets 34, 38 are stacked with spacer 36 therebetween, and large sprocket 38 mounted on stub shaft 32.

Advantageously, assembly 30a provides a plurality of thick walled dowels or tube keys 40 that mate into a bore 42 in stub shaft 32. Preferably, the tube key thickness about 7 millimeters (mm). Further, the tube keys 40 are preferably made from carbon steel tubing. Bolts 44 are then mounted through sprockets 34, 38 and into tube keys 40 in stub shaft 32. Therefore, the joint 45 between sprocket 34 and the stub shaft 32 is strengthened by the tube keys 40. The new assembly 30a transfers load to the combined tube key 40 and bolt 44 assembly.

FIG. 5 depicts another embodiment of a reinforced torque transfer assembly according to the invention, designated as 30b . The drive assembly 30b includes a stub shaft 32, a large diameter sprocket 34 and a small diameter sprocket 38, with a spacer 36 therebetween. The tube key is designated as 40. The drive assembly 30b is similar to the stacked assembly 30a except that the position of the sprockets are reversed, with small sprocket 38 being mounted on the stub shaft 32.

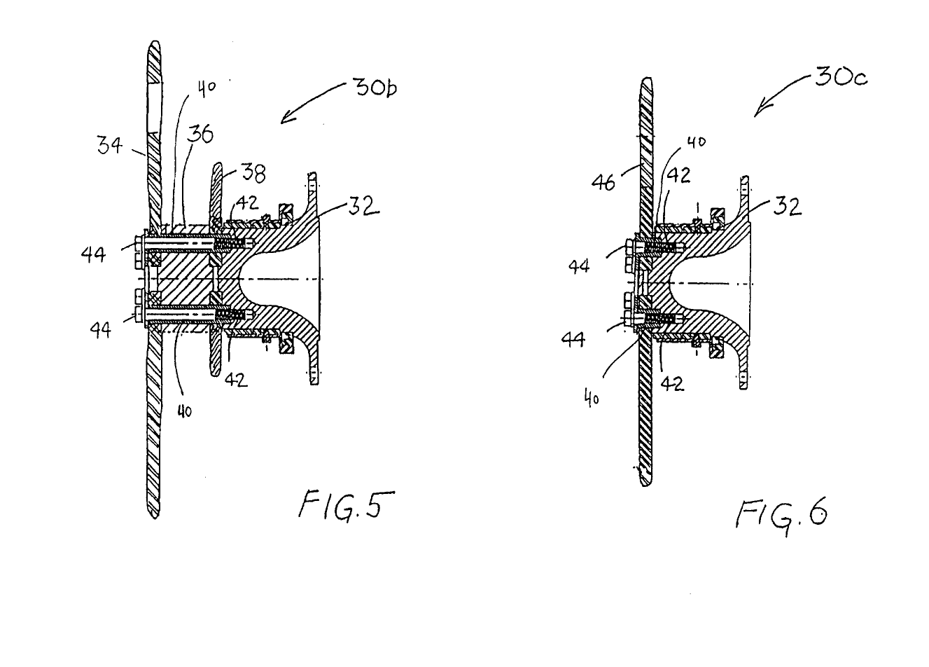

FIG. 6 depicts another embodiment of a reinforced torque transfer assembly, designated as 30c. The drive assembly 30c is composed of a single sprocket 46 mounted on a stub shaft 32. The tube key is designated as 40.

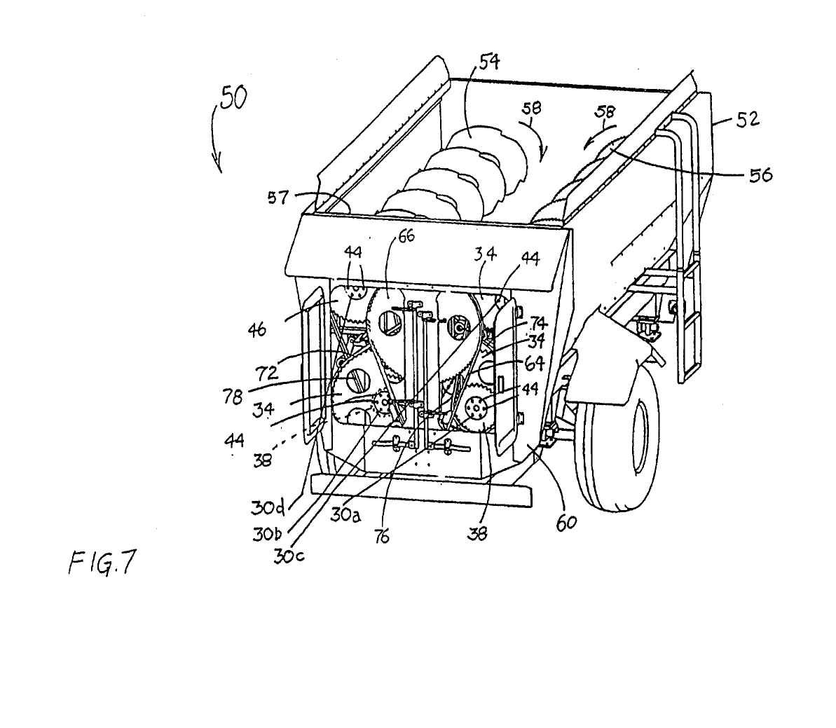

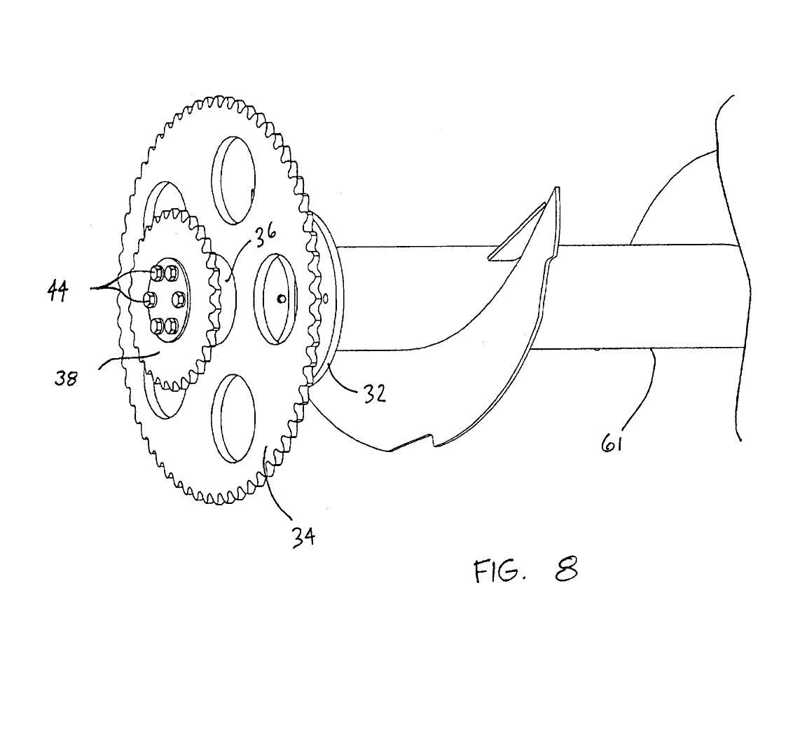

FIG. 7 illustrates the arrangement of the various reinforced torque transfer assemblies in a feed mixer composed of stacked augers within a mixing tank. The reinforced torque transfer system can also be advantageously used in a feed mixer such as those disclosed in U.S. Pat. Nos. 4,597,672, 4,506,990 and 4,741,625 (Neier), incorporated herein by reference, and other torque-driven mechanisms.

As shown, feed mixer 50 is composed of stacked augers including two top augers 54, 56 positioned above two bottom augers (not shown). Each of the augers include central shafts that are rotatably supported and extend through the rearward end wall 57 of the mixer. The two bottom augers rotate clockwise to move hay or other feed material to the front 52 of mixer 50 where the material moves upward to the two top augers 54, 56. Top augers 54, 56 rotate to the inside in the direction of arrow 58, to move material to the back end 60 of mixer 50 where the material cascades to the two bottom augers, whereupon the mixing and blending process is repeated. Upon engagement of the drive linkage, which includes reinforced torque transfer assemblies 30a-d, the upper and lower augers are rotated to cause movement of feed in a circulating path.

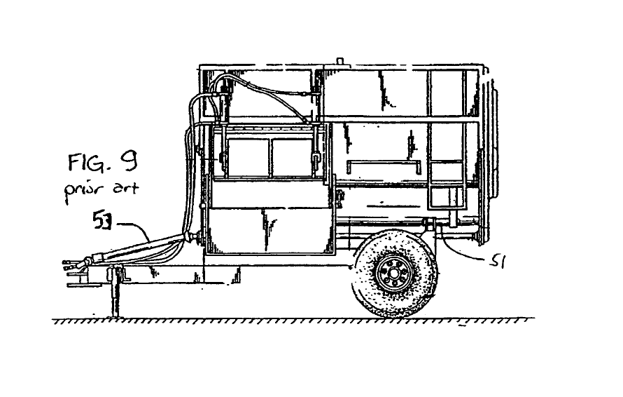

The reinforced torque transfer assemblies 30a-d are shown mounted in the rear end 60 of an auger-type mixer 50. At the front end 52 of mixer 50, a power take-off shaft 51 (as shown in a similar prior art mixer in FIG. 9) connects to a tractor. A line shaft 53 extends underneath mixer 50 from front end 52 to rear end 60, and is connected to a drive mechanism. On the lower right side of mixer 50, assembly 30a (depicted in FIGS. 34) is connected to a bottom auger 61 (FIG. 8), and preferably includes a large diameter sprocket 34 positioned behind a small diameter sprocket 3 8 with spacer 36 therebetween.

On the lower left side of the mixer, assembly 30b (depicted in FIG. 5) is connected to the left hand bottom auger, and preferably includes a large diameter sprocket 34 positioned in front of the small diameter sprocket 38 (shown in phantom), with spacer 36 therebetween.

On the upper right side of the mixer, a torque transfer assembly 30d is connected to the top auger 56. Assembly 30d is similar to that shown in FIG. 5, except that it is preferably composed of a single medium-sized sprocket (rather than the large-sized sprocket of assembly 30b), and sprocket 38 is replaced by a dummy plate.

On the upper left side of the mixer, drive mechanism 30c, connected to the top auger 54, is a stacked arrangement as shown in FIG. 6. Sprocket 46 is connected by chain 78 to a preferably small sprocket 38 (shown in phantom) positioned below on the lower left side of the mixer The combined assembly preferably employs two stages of reduction to power the bottom auger drives, and three stages of reduction to power the top auger drives, by means of the change in size of the sprocket and chain connection between sprockets. Different stages of power reduction may be achieved by replacing the torque transfer assembly sprockets with sprockets of different sizes.

Line shaft 51 extends underneath the mixer and powers a small drive sprocket (not shown) located in the center lower portion of the rear of the mixer. The small drive sprocket is connected by a chain to a large diameter sprocket 66 in the upper middle section. Referring again to FIG. 7, a center jack-shaft is mounted on the large upper sprocket 66, and supports a small diameter drive sprocket (located behind sprocket 66). The small drive sprocket is connected by a chain 72 to the large diameter sprocket 34 mounted on the left-bottom auger positioned beneath the top auger 54. Small drive sprocket is also connected by a chain 74 to the large diameter sprocket 34 mounted on the right-bottom auger positioned beneath right-top auger 56. On the right-bottom side, small diameter drive sprocket 38 is stacked in front of the large sprocket 34, and is connected by a chain 76 to sprocket 34 mounted on top-right auger 56. On the left-bottom side, small diameter drive sprocket 38 (shown in phantom) is stacked behind the large sprocket 34, and is connected by a chain 78 to sprocket 46 mounted on top auger 54.

The drive or the torque transfer assemblies 30a-d are bolted to the lower and upper auger drive shafts and auger tube assemblies, preferably with multiple, evenly spaced bolts. Such an attachment is shown in FIG. 8, with regard to assembly 30a attached to the bottom auger 61. Upon engagement of the drive linkage, the upper and lower augers arc rotated to cause movement of feed in a circulating path. In particular, the bottom sprockets 34 on either side of the mixer drive the bottom augers, and torque is transferred to sprockets 38 in the stack, which, in turn, drive the upper sprockets 46 and 34, that respectively drive the top augers 56, 54.

The reinforced drive of the present invention improves reliability in tough hay processing and mixing situations. Tube keys 40, which are “doweled” through the sprocket and into the stub shaft 32, significantly increase the shear stress capacity, increasing the shear strength by about three times compared to previously known designs. The use of the tube keys 40 also eliminates placing the greatest shear stress on the weakest part of the bolt, i.e., the threaded section. Thus, as the chain pulls on and rotates the sprocket, the bolts resist tension and maintain the sprockets mounted on the stub shaft.

The invention has been described by references to detailed examples and methodologies. These examples are not meant to limit the scope of the invention. Variations within the concepts of the invention are apparent to those skilled in the art.

I claim:

1. A torque transfer assembly comprising:
at least one disk member and a shaft,
at least one fastener reinforced; and a tube key surrounding at least a portion of the fastener;
wherein the disk member is mounted onto the shaft with the fastener and tube key

2. The torque transfer assembly of claim 1 wherein the at least one disk member is a sprocket.

3. The torque transfer assembly of claim 1 wherein the shaft is connected to an auger, whereby when the at least one disk member rotates, the auger rotates.

4. The torque transfer assembly of claim 1 wherein the tube key surrounds a portion of the fastener in a sleeve-like manner.

5. The torque transfer assembly of claim 4 wherein the tube key surrounds the portion of the fastener that is subjected to the highest shear stresses.

6. The torque transfer assembly of claim 1 further including a spacer located between a first disk member and a second disk member.

7. A method of driving an auger comprising the steps of:
presenting a torque transfer assembly comprised of at least a first disk member and a second disk member attached to a shaft with reinforced fasteners;
attaching the auger to the torque transfer assembly;
rotating the first disk member in order to drive the auger.

8. A torque transfer assembly comprising:
at least one sprocket mounted onto a shaft,
at least one fastener reinforced with a tube key;
wherein the sprocket is mounted onto the shaft with the reinforced fastener so that the tube key is positioned on a portion of the fastener that experiences shear stress.

9. The torque transfer assembly of claim 8 wherein the tube key has a wall thickness of about 7 mm.

10. The torque transfer assembly of claim 8 wherein the shaft is a stub shaft.

11. The torque transfer assembly of claim 10 further including a spacer and a second sprocket, wherein the spacer is located between the second sprocket and the at least one sprocket.

12. The torque transfer assembly of claim 8 wherein the fastener is threaded.

13. The torque transfer assembly of claim 8 wherein the reinforced fasteners are substantially parallel to the rotational axis of the shaft.

14. A feed mixer comprising:
a mixing tank;
at least one top auger rotatably connected within the mixing tank;
at least one bottom auger rotatably connected within the mixing tank so that it is
positioned underneath the top auger and substantially parallel thereto;
wherein at least one of the top and bottom augers is driven via a torque transfer assembly, comprising:
at least one disk member and a shaft;
at least one fastener reinforced; and a tube key surrounding at least a portion of the fastener;
wherein the disk member is mounted onto the shaft with the fastener and tube key.

15. The torque transfer assembly of claim 14 wherein the at least one disk member is a sprocket.

16. The torque transfer assembly of claim 14 wherein the tube key has a wall thickness of about 7 millimeters.

17. The torque transfer assembly of claim 14 wherein the tube key surrounds the portion of the fastener that is subjected to the highest shear stresses.

18. The torque transfer assembly of claim 14 further including a spacer located between a first disk member and a second disk member.
